(19) United States
(12) Patent Application Publication
(10) Pub. No.: US 2015/0186665 A1
(43) Pub. Date: Jul. 2, 2015

(54) SYSTEMS AND METHODS FOR THE GENERATION, DISPLAY, AND CAPTURE OF A DATA SET WITH A BROADCAST SIGNATURE

(71) Applicant: Toshiba Global Commerce Solutions Holdings Corporation, Tokyo (JP)

(72) Inventors: Dean F. Herring, Youngsville, NC (US); Brad M. Johnson, Raleigh, NC (US); D. Scott Miller, Wake Forest, NC (US); Jeffrey J. Smith, Raleigh, NC (US)

(73) Assignee: Toshiba Global Commerce Solutions Holdings Corporation, Tokyo (JP)

(21) Appl. No.: 14/171,000

(22) Filed: Feb. 3, 2014

Related U.S. Application Data
(60) Provisional application No. 61/922,923, filed on Jan. 2, 2014.

(51) Int. Cl. G06F 21/62; G06F 21/60

(52) U.S. Cl. CPC G06F 21/6209; G06F 21/602

(57) ABSTRACT

Systems and methods for the generation, display and capture of a data set with a broadcast signature are disclosed. According to an aspect, a method may include receiving a first data set and at least one second data set. The method may also include generating an encoded first data set for display and generating at least one encoded second data set for display, wherein the at least one encoded second data set is mathematically encrypted. Further, the method may include displaying the encoded first data set and displaying the at least one encoded second data set.

### CROSS REFERENCE TO RELATED APPLICATION

This application claims the benefit of U.S. Provisional Patent Application No. 61/922,923, filed Jan. 2, 2014 and titled SYSTEMS AND METHODS FOR THE GENERATION, DISPLAY, AND CAPTURE OF A DATA SET WITH A BROADCAST SIGNATURE, the content of which is hereby incorporated herein by reference in its entirety.

### TECHNICAL FIELD

The present invention relates to retail devices and equipment, and more specifically, to generation, display, and capture of a data set with a broadcast signature.

### BACKGROUND

In retail environments, such as grocery stores and other “brick and mortar” stores, retail personnel interact with customers, products, or other objects located in the retail environment. As an example, the retail environments comprising the grocery store or other “brick and mortar” store may wish to provide product or other information for the customer. The product or other information may be paper or electronic based, such as pamphlets, books or the electronic based information could be in the form of internet or web access. The electronic based information may also be in the form of product look up information, such as, product specifications in a store's database. Over time, techniques have been developed which provide for easier data entry in which the electronic based information is provided or displayed. As an example, a machine readable barcode or a two dimensional Quick Response (QR) code may be displayed next to or attached to a product and used by the customer or the retail personnel to provide product, store or other information that relates to the shopping experience. However, presenting the customer with this information can generate additional questions which the store may wish to provide further relevant detail to the retail personnel but not directly to the customer. Presently, it is necessary to provide retail personnel with separate material to provide the further information for the customer. In many retail environments, retail personnel may carry a mobile computing device, such as a tablet computer, configured with retail sales functionality for conducting sales transactions, conducting inventory tasks, and the like. However, there is a need for devices and techniques that provide a more versatile and mobile solution for retail personnel to interact with items and customers, minimizing data entry and product look up information, while expanding the type and level of information available.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for the generation, display and capture of a data set with a broadcast signature. According to an aspect, a method may include receiving a first data set and at least one second data set. The method may also include generating an encoded first data set for display and generating at least one encoded second data set for display, wherein the at least one encoded second data set is mathematically encrypted. Further, the method may include displaying the encoded first data set and displaying the at least one encoded second data set.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an exemplary system for the generation, display and reading of a plurality of data sets, wherein one or more of the data sets require an encryption key according to embodiments of the present invention;

FIG. 2 is a diagram showing an exemplary encoded first data set and a second data set as two dimensional Quick Response codes, wherein the encoded second data set is also encrypted, in accordance with embodiments of the present invention;

FIG. 3 is a diagram which shows an exemplary encoded first and second data set displayed over a period of time in accordance with embodiments of the present invention; and

FIG. 4 is a flowchart of an exemplary method of using the system of FIG. 1 showing the receiving of a data set, generation of a code by encoding the received data sets, the display of the generated encoded data sets, in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

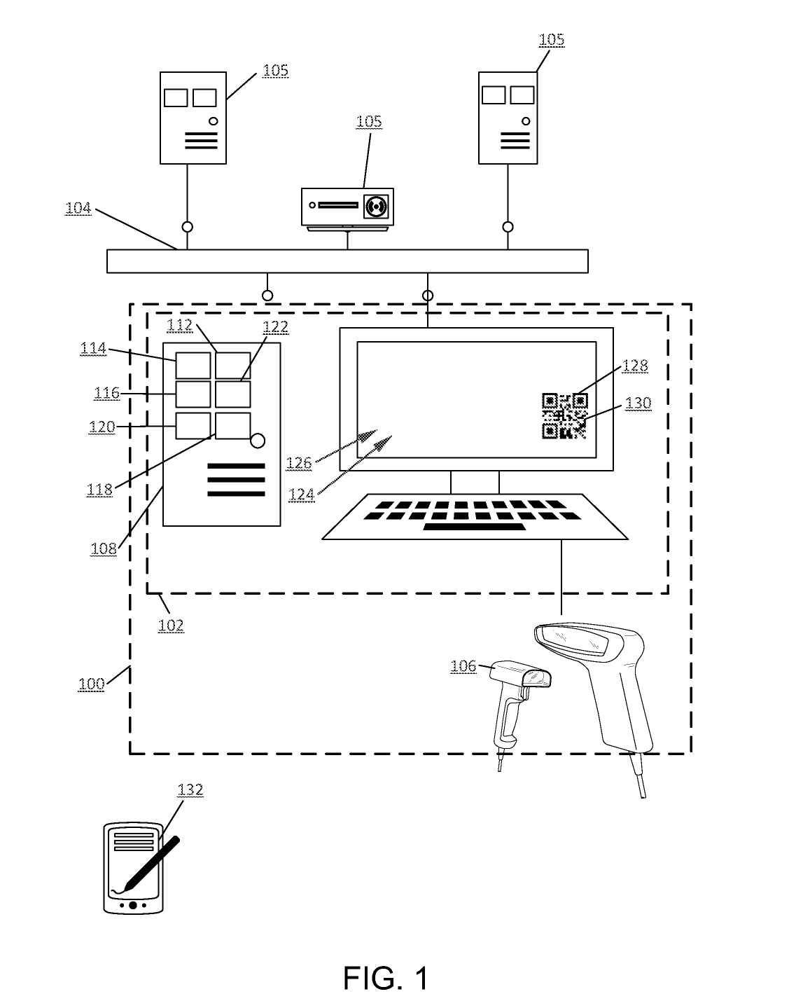

The presently disclosed invention is now described in more detail. For example, FIG. 1 illustrates a block diagram of a system 100 according to embodiments of the present invention. The system 100 may be implemented in whole or in part in any suitable environment, such as a retail environment. For example, the system 100 may be implemented in a retail store having a variety of products or items for purchase and one or more point of sale (POS) terminals. For example, a computing device 102 may operate as a POS device that can be operated by retail personnel for conducting purchase transactions with customers or for processing products within the retail environment (e.g., inventory of products). The computing device 102 may be communicatively connected to a communications network 104, which may be any suitable wide area network (WAN), local area network (LAN), either wireless (e.g., BLUETOOTH® communication technology) and/or wired. The computing device 102, and other components, not shown, may be configured to acquire data within the retail environment, to process the data, and to communicate the data to a centralized server. For example, the computing device 102 and a server(s) 105 may operate together to implement a retail function and to communicate data related thereto to a server. The server 105 may reside in the retail store or be remotely located.

In continuing reference to FIG. 1, the components of the system 100 may each include hardware, software, firmware, or combinations thereof. For example, software residing in memory of a respective component may include instructions implemented by a processor for carrying out functions disclosed herein. As an example, the system 100 comprises a computing device 102, and a data set reading device 106. The computing device 102 comprises an encoded data set generator 108 and an electronic display 110 (e.g., a touchscreen display, computer monitor, and the like). The system 100 also comprises the data set reading device 106 which may be a barcode scanner, and/or other equipment for interfacing with retail personnel and for conducting a purchase transaction for purchase of items by customers, as an example. The computing device 102 may also include memory 112, a processor 114, and a battery 116. The computing device 102 may be configured to implement POS or other retail functionality. The computing device 102 may also include a communications network interface 118 for communicating with the network 104. The computing device 102 may include hardware (e.g., image capture devices, scanners, and the like) for capture of various data within the retail environment. For example, the computing device 102 may include an image capture device (e.g., a camera) for capturing one or more images of a retail item (e.g., a product) and interaction of a user's hand or finger with the item. In another example, the computing device 102 may include a scanner for scanning items for inventory or for POS functions (e.g., customer purchase of a scanned product). Further, the computing device 102 may also include an optional GPS 120 to be used by the computing device 102 to identify the precise location of the computing device 102. Further, the computing device 102 may include an accelerometer 122 to enable the computing device 102 to determine precise orientation of the computing device 102.

In continuing reference to FIG. 1, the encoded data set generator 108 of the computing device 102 is configured to receive a first data set 124 and a second data set 126. The first data set 124 is a data set representing information intended for general display and use by a general user (e.g., a customer, a patient, and the like). The first data set 124 may be a data set that represents a web page, product specifications, and/or sales, as an example. The second data set 126 is a data set representing information intended to be viewed by an authorized user, such as a store employee, subscriber or other user that is authorized to view the second data set 126. As an example, the second data set 126 may comprise information not intended for general viewing (e.g., competitive pricing, internal pricing, and the like). Using the first data set 124 and the second data set 126, the encoded data set generator 108 generates a displayable code. In this example, the displayable code is a two dimensional Quick Response (QR) code, however, it should be noted that other displayable codes such as a barcode or other machine readable codes may be used. The displayable code is any code capable of providing machine readable information on an electronic display. The encoded data set generator 108 generates an encoded first data set 128 for display from the first data set 124 received. In this example, the encoded first data set 128 is a standard Quick Response (QR) code, but may also be another displayable type code. The encoded data set generator 108 also encodes the one or more second data sets 126 for display as one or more encoded second data sets 130. The one or more encoded second data sets 130 may also be mathematically encrypted by the encoded data set generator 108. The one or more encoded second data sets 130 may be encrypted using are variety of mathematical schemes, including a scheme based on the Fourier Transform Series.

In continuing reference to FIG. 1, decrypting the encrypted one or more encoded second data sets 130 uses an encryption key which corresponds to the encryption key used to encrypt the data set. The encryption key may be programmed or otherwise stored in the data set reading device 106 and used to decrypt the one or more encoded second data sets 130. In this manner, the encoded first data set 128 may be generally viewable and decoded by widely available scanners or readers, such as a smartphone 132 with generally available scanning software. However, in one example, the one or more encoded second data sets 130 may only be viewed, decoded or actionable when read with a data set reading device 106 comprising the encryption key. The computing device 102 also comprises an electronic display 110 configured to display the encoded first data set 128 and the one or more encoded second data sets 130. The data set reading device 106 is configured to receive, decrypt and decode both the displayed encoded first data set 128 and the one or more encoded second data sets 130. The reader should also note that the encoded data set generator 108 may receive, generate, and display more than two data sets. The data set reading device 106 may also decrypt more than two data sets based on using corresponding encryption key(s).

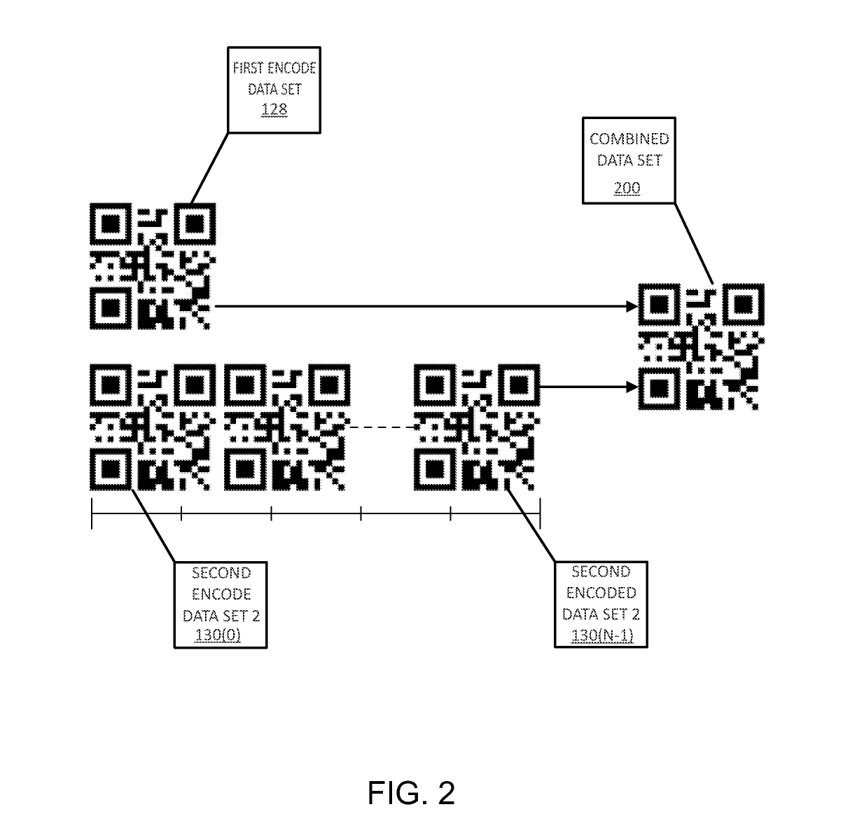

In accordance with embodiments of the present invention, FIG. 2 is a diagram which illustrates an exemplary encoded first data set 128 and one or more encoded second data sets 130 as a two dimensional Quick Response (QR) code, wherein the encoded second data set 130 is also encrypted. The one or more encoded second data sets 130 is displayed as a series of second data set 130(0)-130(N−1) encodings, based on the type of mathematical encryption used there may be up to N encodings of the one or more encoded second data sets. For example, the one or more encoded second data set 130 may be displayed as a series of encodings 130(0)-130(N−1), wherein the displayed code properties of color, position, and/or size of the encoded elements change over time. Further, the encrypted encodings may be encrypted based on a time based encryption scheme. For example, the encryption may be based on the encryption time of day. The encryption scheme may also be based on the size of the displayed encoded data set. The displayed code properties change over time according to the mathematical encryption used by the encoded data set generator 104. The encoded first data set 128 and encoded second data set 130(0)-130(N−1) of FIG. 2 is described as being generated by the encoded data set generator 108 in the computing device 102, although the encoded first data set 128 and encoded second data set 130(0)-130(N−1) may be generated by any suitable device(s). The second data set 130(0)-130(N) encodings may be displayed in a flashing manner and is performed so as to not affect the reading of the main steady state encoded data sets 128, 130(0)-130(N). The displaying in a flashing manner may be at such a speed or frequency so as to appear like a main steady state, in this embodiment the de-encrypting data set reading device 106, would pick up the second data set 130(0)-130(N) displayed in a flashing manner as video feed. In another embodiment, the compositely displayed QR code has a flashing state such that the flashing may be at such a speed or frequency that the first encoded data set 128 is read by the smart phone 132 (i.e. consumer device capable of reading the first encoded data set 128). The encoded first data set 128 and encoded second data set 130(0)-130(N−1) may be implemented by hardware, software, and/or firmware of the computing device 102, and/or another computing device.

In continuing reference to FIG. 2, the encoded first data set 128 and encoded second data set 130(0)-130(N−1) are displayed to the electronic display 110 as a steady pattern for general viewing and reading. As discussed above, the encoded first data set 128 in FIG. 2. is displayed as a QR code, however the one or more encoded second data sets 130(0)-130(N−1) may appear displayed with alternate and/or additive bits of the code being presented to the screen as an encrypted dark and light pattern that changes with a mathematically formula. The data set reading device 106 used by the store employees reading the encoded first data set 128 and/or the encoded second data set 130(0)-130(N−1) may require an encryption key or a mathematical filter that is able to read the broadcast signature of the encoded second data set 130(0)-130(N−1). In this example, the encoded first data set 128 would be displayed in a steady state, while the encoded second data set 130(0)-130(N−1) would have bits that turn on and/or off over a time period based on the mathematical encryption used. The steady state bits of the encoded first data set 128 are able to be read by standard two dimensional QR code means. In this example, the encoded second data set 130(0)-13(N−1) may not be readable by the standard means but could be read by the data set reading device 106 using an encryption key to decrypt the second encoded data set 130(0)-130(N−1).

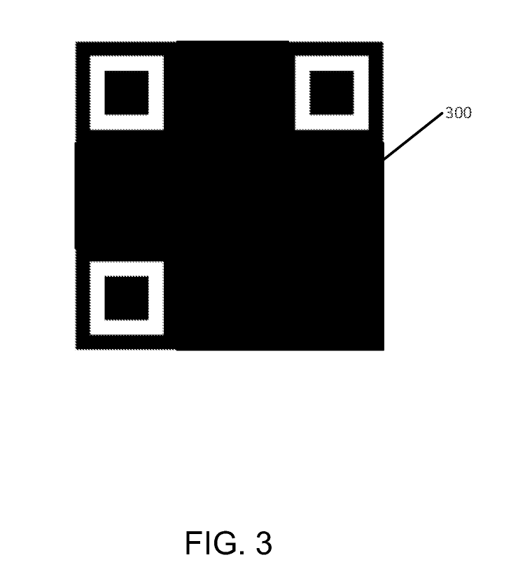

In accordance with embodiments of the present invention, FIG. 3 is a diagram 300 which shows an exemplary encoded first and second data set over a period of time. One data set is delivered to the screen as a steady illuminated area while the other data set is flashed to the screen encrypted by a mathematical formula such as a complex Fourier series type sine wave. A standard mobile device with software to read the displayed code can read the first data set since it is steadily illuminated. A data set reading device 106 with the broadcast signature or encryption key matching the mathematical encryption formula of the emitting device can read the one or more encoded second data sets 130(0)-130(N−1). The data may have a start and stop sequence that enables the devices to pair up such that the data set reading device 106 is configured to match the start of the reading of the one or more encoded second data sets 130(0)-130(N−1). The start of the sequence corresponds to the mathematical sequence series, wherein the start of the reading begins with the first of the series of one or more encoded second data sets 130(0). The encoded first data set 128, as discussed above, is steadily displayed on the electronic display 110. The one or more encoded second data sets 130(0)-130(N−1) changes over a period of time based on the mathematical encryption used. When viewed over a period of time (e.g., a video of the displayed encoded data sets 128, 130(0)-130(N−1) were taken) the displayed data sets may show all bits illuminated and may not be readable. However, in the example where a video were taken of the displayed encoded data sets, if the video were viewed one video frame at a time, the frames would not reveal the filter key. In this example, a standard reading device without the encryption key would not be able to read the encoded second data set 130(0)-130(N−1).

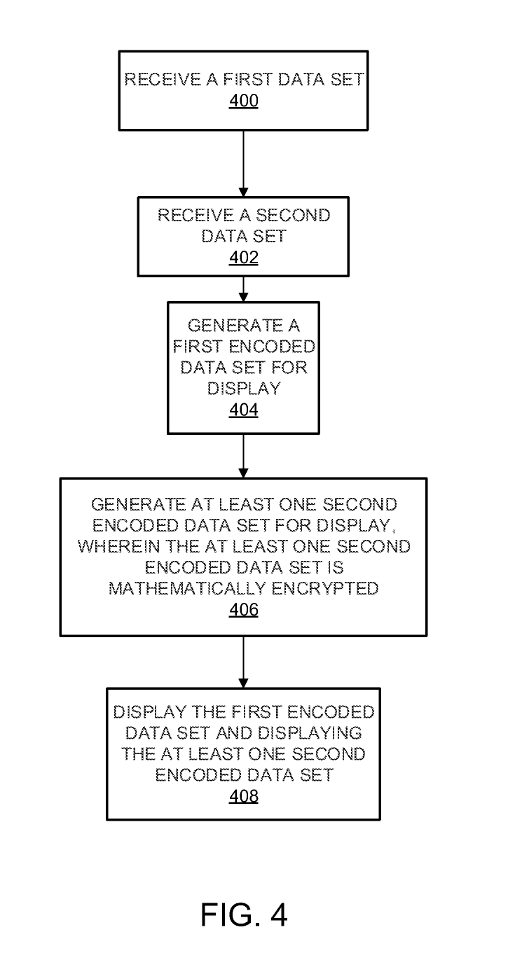

In accordance with embodiments of the present invention, FIG. 4 is a flowchart of an exemplary method of the system of FIG. 1 showing the receiving of a data set, the generation of a displayable code by encoding the received data sets and the display of the generated encoded data sets. It is noted that the example method may be implemented by an encoded data set generator, although it should be understood that the method may be implemented by one or more components of one or more computing devices of any suitable type. Further, the example method may be implemented in any suitable environment such as, but not limited to, the system shown in FIG. 1. In block 400, the method in FIG. 4 may receive the first data set 124. Additionally, one or more second data sets 126 may be received (block 402). The encoded data set generator 104 generates the encoded first data set 128 for display from the first data set 124 (block 404). The encoded data set generator 104 generates the one or more encoded second data sets 130(0)-130(N−1) for display, wherein the one or more encoded second data sets 130(0)-130(N−1) is mathematically encrypted (block 406). The encoded data set generator 104 may then display the combined data set 200 comprised of both the encoded first data set 128 and the one or more encoded second data sets 130(0)-130(N<1) (block 408).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
receiving a first data set;
receiving at least one second data set;
generating an encoded first data set for display;
generating an at least one encoded second data set for display, wherein the at least one encoded second data set is mathematically encrypted;
displaying the encoded first data set; and
displaying the at least one encoded second data set.

2. The method of claim 1, wherein the at least one encoded second data set is encrypted mathematically using a time based encryption.

3. The method of claim 1, wherein the at least one encoded second data set is encrypted mathematically using a color based encryption.

4. The method of claim 1, wherein the at least one encoded second data set is encrypted mathematically using a position based encryption.

5. The method of claim 1, wherein the at least one encoded second data set is encrypted mathematically using a size based encryption.

6. The method of claim 1, wherein the at least one encoded second data set is encrypted mathematically using a Fourier series based encryption.

7. The method of claim 1, wherein the encoded first data set and the at least one encoded second data set are QR codes.

8. A computer program product comprising a computer readable storage medium having program instructions embodied therewith, the program instructions executable by a computing device to cause the computing device to:
receive, by the computing device, a first data set;
receive, by the computing device, at least one second data set;
generate, by the computing device, an encoded first data set for display;
generate, by the computing device, at least one encoded second data set for display, wherein the at least one encoded second data set is mathematically encrypted;
display, by the computing device, the encoded first data set; and
display, by the computing device, the at least one encoded second data set.

9. The computer program product of claim 8, wherein the program instructions are executable by the computing device to cause the computing device to encrypt the at least one encoded second data set mathematically using a time based encryption.

10. The computing program product of claim 8, wherein the program instructions are executable by the computing device to encrypt the at least one encoded second data set mathematically using a color based encryption.

11. The computing program product of claim 8, wherein the program instructions are executable by the computing device to encrypt the at least one encoded second data set mathematically using a position based encryption.

12. The computing program product of claim 8, wherein the program instructions are executable by the computing device to encrypt the at least one encoded second data set mathematically using a size based encryption.

13. The computing program product of claim 8, wherein the program instructions are executable by the computing device to encrypt the at least one encoded second data set mathematically using a Fourier series based encryption.

14. The computing program product of claim 8, wherein the program instructions are executable by the computing device to encode the encoded first data set and the at least one encoded second data set as QR codes.

15. A system comprising:
an encoded data set generator configured to:
receive a first data set;
receive at least one second data set;
generate a encoded first data set for display; and
generate at least one encoded second data set for display, wherein the at least one encoded second data set is mathematically encrypted;
an electronic display configured to:
display the encoded first data set; and
display the at least one encoded second data set; and
a data set reading device configured to:
receive the encoded first data set;
decode the encoded first data set;
receive the at least one encoded second data set; and
decode the at least one encoded second data set using an encryption key to mathematically decrypt the at least one encoded second data set.

16. The system of claim 15, wherein the at least one encoded second data set is encrypted mathematically using a time based encryption.

17. The system of claim 15, wherein the at least one encoded second data set is encrypted mathematically using a color based encryption.

18. The system of claim 15, wherein the at least one encoded second data set is encrypted mathematically using a position based encryption.

19. The system of claim 15, wherein the at least one encoded second data set is encrypted mathematically using a size based encryption.

20. The system of claim 15, wherein the at least one encoded second data set is encrypted mathematically using a Fourier series based encryption.

21. The system of claim 15, wherein the encoded first data set and the at least one encoded second data set are QR codes.
